(19) United States
(12) Patent Application Publication
(10) Pub. No.: US 2006/0091077 A1
(43) Pub. Date: May 4, 2006

(54) Concentrate recycle loop with filtration module

(75) Inventors: William E. Haas, Norfolk, VA (US); Abel P. Queen, Norfolk, VA (US)

Correspondence Address: VENABLE LLP, P.O. BOX 34385, WASHINGTON, DC, 20045-9998, US

(73) Assignee: Ecolochem, Inc., Norfolk, VA (US)

(21) Appl. No.: 10/975,543

(22) Filed: Oct. 29, 2004

(51) Int. Cl. B01D 61/44

(52) U.S. Cl. 210/641; 210/651; 210/748; 210/202; 210/259; 204/630; 204/638; 204/639; 204/520; 204/535

(57) ABSTRACT

Water purification systems include a concentrate filtration membrane and an electrodeionization unit. A concentrate effluent stream from the electrodeionization unit is filtered in the concentrate filtration membrane; the filtered concentrate effluent stream is provided to concentrating compartments of the electrodeionization unit.

### BACKGROUND OF THE INVENTION

1. Field of the Invention

The present invention relates to a water purification system. More particularly, a water purification system in which a concentrate effluent stream is filtered to remove impurities such as biological foulants to produce a filtered concentrate effluent stream which is used in the concentrating compartment of an electrodeionization unit is presented.

2. Description of the Related Art

Highly purified water having a small concentration of ions and other contaminants is required for a number of industrial applications. For example, highly purified water must be used in the manufacture of electronic microchips: mineral contaminants can induce defects. Highly purified water is used in the power generation industry to minimize the formation of scale on the interior of pipes and thereby ensure good heat transfer within and unrestricted water flow through heat exchange systems. The use of highly purified water reduces the formation of scale and deposits in water lines of heat exchange systems, thus extending the time interval between required maintenance procedures. The time interval between required maintenance procedures of a heat exchanging system should be as long as possible. Prolonging the time interval between required maintenance procedures is of particular importance in nuclear power systems, which require complex and expensive shutdown and startup procedures and adherence to radiation safety protocols.

Several technical approaches towards water purification exist, including the use of ion exchange resins. However, the need to periodically regenerate ion exchange resins requires a complex arrangement of pumps, piping, valves, and controls with associated large capital and maintenance costs and the use of regenerating chemicals which must be disposed of as chemical waste.

An alternative approach towards water purification is electrodialysis. An electrodialysis unit can include a positively charged anode, a negatively charged cathode, and alternating concentrating compartments and diluting compartments interposed between the anode and cathode. The electrical field established between the electrodes is understood to cause negatively charged anions to diffuse towards the anode and positively charged cations to diffuse towards the cathode. The concentrating compartments and diluting compartments are separated by compartment separation membranes. A compartment separation membrane can include, for example, an anion exchange membrane or a cation exchange membrane. An anion exchange membrane bounds a diluting compartment on the side closer to the anode and allows anions to pass through while restraining the passage of cations. A cation exchange membrane bounds a diluting compartment on the side closer to the cathode and allows cations to pass through while restraining the passage of anions. Direct electrical current is made to flow between the anode and the cathode to remove ions from the diluting compartments and to concentrate ions in the concentrating compartments. A diluting feed stream of water can be continuously provided to the diluting compartments and a concentrating feed stream can be continuously provided to the concentrating compartments. The product stream flowing out of the diluting compartments is purified with respect to the diluting feed stream and contains a smaller concentration of ions than the diluting feed stream; the product stream can be further purified or can be provided to an industrial process for use. The concentrate effluent stream flowing out of the concentrating compartments contains a larger concentration of ions than the concentrating feed stream and can be recycled or discharged to a waste unit. An electrodialysis unit does not require the use of regenerating chemicals. Electrodialysis units are manufactured by Ionics, Incorporated of Watertown, Mass.

Energy can be consumed by a water purification system in, for example, increasing the pressure of a supply stream of water in order to drive permeate through a membrane that filters out impurities, or in applying direct current across electrodes to drive ions into concentrating compartments in an electrodialysis unit. In an electrodialysis unit, it is understood that a large resistance, i.e., a small conductance, across the diluting compartment, the concentrating compartment, or both can result in a large fraction of the electrical energy supplied being dissipated as heat without driving the motion of many ions. The electrical energy required to produce a unit volume of purified water can be reduced by increasing the conductance across the concentrating compartment by, for example, ensuring a large concentration of ions in the concentrating compartment by recycling the concentrate effluent stream to the entrance of the concentrating compartment or by adding salt to the concentrating feed stream.

The problem of small conductance across the diluting compartment is addressed with an electrodeionization unit. The basic design of an electrodeionization unit is similar to that of an electrodialysis unit. However, diluting compartments of an electrodeionization unit contain ion exchange beads which increase conductance across the diluting compartment. The ion exchange beads have positively and negatively charged sites; these sites facilitate the efficient migration of ions through the diluting compartment even when the conductivity of the diluting feed stream is low.

Electrodeionization units can require periodic maintenance to clean compartment separation membranes which have become fouled and through which the passage of ions has become impeded. Such cleaning can require the water purification system to be shut down for hours or days. In addition to the cost associated with the cleaning operation, the shutdown time can, for example, lead to interruption of a production process dependent on purified water, require investment in large storage capacity for purified water, or require investment in an auxiliary water purification system. Cleanings degrade the compartment separation membranes and can result in the need to frequently replace the expensive membranes. Compartment separation membranes can become fouled through the deposition of impurities such as scale formed from polyvalent ions such as Ca²⁺ and Mg²⁺ and counterions. Deposition of other impurities, such as biological foulants, can foul compartment separation membranes.

As mentioned above, the concentrating feed stream should contain a large concentration of ions so that the conductance across the concentrating compartments is large. In one approach to ensure a large concentration of ions in the concentrating compartments, a water purification system incorporates a pump which cycles the concentrate effluent stream exiting the concentrating compartment of the electrodeionization unit back into the concentrating compartments. The subsystem including the pump, piping connecting the pump to the inlets and outlets of concentrating compartments, and concentrating compartments can be termed a concentrate loop. An example of a water purification system incorporating a concentrate loop is presented in U.S. Pat. No. 6,565,726 B2 to Sato. As ions are driven by the applied direct current from the diluting compartments into the concentrating compartments, the concentration of ions in the concentrate loop, including the concentrating compartments, increases. Eventually, a large concentration of ions in the concentrating compartments can result in a large conductance across the concentrating compartments. However, when the electrodeionization system is first started, there may be only a small concentration of ions in the concentrating compartments; to increase the conductivity of the fluid in and the conductance across the concentrating compartments at start up, salt as a source of ions can initially be injected into the concentrate loop. The injected salt can be a monovalent salt, that is, a salt in which the ions which associate to form the salt are monovalent, such as sodium chloride.

Polyvalent ions driven from the diluting compartments into the concentrating compartments can accumulate in a concentrate loop. When the concentration of accumulated polyvalent ions becomes sufficiently large, the polyvalent ions with associated counterions can precipitate as scale on the side of a compartment separation membrane adjacent to a concentrating compartment and thereby foul the membrane. Bacteria and other organisms can grow in the concentrate loop. Biological foulants, for example, organisms and compounds produced by organisms can deposit on and foul the compartment separation membranes. A bleed stream from the concentrate loop can be used to remove impurities from the concentrate loop. The fluid in the concentrate loop that is continuously bled off can be made up by a make up stream that continuously provides additional fluid to the concentrate loop. The reduction of impurities in the concentrate loop to a level for which biological foulants, scale, and other impurities accumulate on compartment separation membranes at no greater than a predetermined acceptable rate can require a large flow rate of the bleed stream and of the make up stream. The ratio of the flow rate of the product stream flowing out of the electrodeionization unit, which can be termed the EDI product stream, to the flow rate of the supply stream, which provides water for the diluting feed stream and for a make up stream, can range between zero and one; the closer the ratio is to one, the more efficiently the water purification system uses the water of the supply stream. The inclusion of a bleed stream and of a make up stream in the water purification system decreases the ratio of the flow rate of the EDI product stream to the flow rate of the supply stream. It may be necessary to filter the water in the supply stream that is provided as the make up stream to minimize the introduction of impurities such as organisms, other biological foulants, and polyvalent ions into the concentrate loop. For example, in U.S. Pat. No. 6,056,878 to Tessier et al., FIG. 3 illustrates that reverse osmosis permeate is provided to the diluting compartments and is provided as make up water to the concentrate loop. The reverse osmosis membrane filters out polyvalent ions and bacteria; as a result, the use of the reverse osmosis permeate in the concentrate loop can reduce the rate of fouling of the compartment separation membranes from the rate if unfiltered supply water were used. Nevertheless, although the make up stream may contain no or only a small amount of bacteria and other organisms, it is difficult to maintain complete sterility, and the system illustrated in FIG. 3 of U.S. Pat. No. 6,056,878 does not have a way to eliminate organisms which grow in the concentrate loop. Filtration of the water used in the make up stream also represents an additional capital cost. For example, the use of the reverse osmosis permeate for make up water in the system illustrated in FIG. 3 of U.S. Pat. No. 6,056,878 requires a larger capacity reverse osmosis unit for a given volumetric flow rate of an EDI product stream than if the reverse osmosis unit permeate were not used as make up water.

An antiscalant agent can be injected into the concentrating feed stream to prevent or delay the precipitation of polyvalent ions and associated counterions as scale. An antiscalant agent injection device contributes to capital and maintenance costs and increases the bulk and weight of a water purification system. An antibiological agent capable of killing bacteria and other organisms can be injected into the concentrating feed stream, but the antibiological agent must eventually be disposed of as waste, and an antibiological agent injection device contributes to capital and maintenance costs. Certain antibiological agents can also shorten the life of components in the water purification system. For example, chlorine can function as an antibiological agent, but can degrade the compartment separation membranes and the ion exchange resin in the diluting compartments of the electrodeionization unit. An ultraviolet light device can irradiate fluid in the concentrate loop to kill bacteria and other organisms; however, neither an ultraviolet light device nor an antibiological agent can eliminate the residue of the killed organisms.

In an alternative approach, a concentrate loop is not used in a water purification system incorporating an electrodeionization unit. Instead, fluid in a concentrating feed stream is continuously provided to and passed only once through the concentrating compartments with no recycle of the fluid. Because fresh fluid in the concentrating feed stream is continuously provided to the concentrating compartments in a one pass system, the concentration of impurities such as polyvalent ions and biological foulants, such as bacteria, in the concentrating compartments can be low. A one pass system can require less frequent cleaning of compartment separation membranes than a system incorporating a concentrate loop. Electropure, Inc. of Laguna Hills, Calif. manufactures a one pass unit, the Electropure EDI.

However, a traditional one pass system that provides a portion of the supply stream to the diluting compartments and the remainder to the concentrating compartments of an electrodeionization unit is consumptive of water and has a low ratio of the EDI product stream flow rate to the supply stream flow rate. The large rate of consumption of water contributes to the operating cost of a traditional one pass system. If the supply stream is filtered, for example, by a reverse osmosis unit, before being provided to the diluting compartment and to the concentrating compartment of an electrodeionization unit, the required capacity and the associated capital cost of the filter for a given EDI product stream flow rate can be greater than in a system incorporating a concentrate loop. Because ions driven from the diluting compartments into the concentrating compartments are not recycled to the concentrating compartments, there can be a need to continually inject salt as a source of ions into the concentrating feed stream of a traditional one pass system. The need to inject salt results in increased capital and maintenance costs associated with a salt injection device. The greater flow rate of supply stream water for a given flow rate of the EDI product stream in a traditional one pass system than in a system incorporating a concentrate loop can result in a traditional one pass water purification system being less environmentally friendly than a water purification system incorporating a concentrate loop.

FIG. 1 of U.S. Patent Publication No. 2002/0125137 A1 of Sato et al. illustrates a system in which a portion of an EDI product stream is provided as the concentrating feed stream to the concentrating compartments of an electrodeionization unit. The system resembles a traditional one pass water purification system in that the concentrate effluent stream is disposed of as waste and is not recycled to the concentrating compartments. Thus the system illustrated in FIG. 1 of U.S. Patent Publication No. 2002/0125137 A1 does not appear to use the water of the supply stream efficiently.

There thus remains an unmet need for a water purification system that can operate for a long time before the compartment separation membranes of an electrodeionization unit must be cleaned to remove accumulated biological foulants, and that is environmentally friendly in having a large ratio of the flow rate of the EDI product stream to the flow rate of the supply stream.

### SUMMARY

It is therefore an object of the present invention to provide water purification systems that can operate for a long time before the compartment separation membranes of an electrodeionization unit must be cleaned to remove accumulated biological foulants, and that are environmentally friendly in having a large ratio of the flow rate of the EDI product stream to the flow rate of the supply stream.

An embodiment of a water purification system of the present invention includes an electrodeionization unit and a concentrate filtration membrane. The electrodeionization unit can produce an EDI product stream and can include a diluting compartment for receiving a diluting feed stream and a concentrating compartment for receiving a concentrating feed stream and for outputting a concentrate effluent stream. The concentrate filtration membrane can remove biological foulants from the concentrate effluent stream of the electrodeionization unit to produce a filtered concentrate effluent stream. The concentrating compartment of the electrodeionization unit can receive the filtered concentrate effluent stream. Biological foulants can include bacteria, protists, protazoa, algae, fungi, yeast, pollen, component cells of multicellular organisms, fragments of organisms, subcellular organelles, cell walls, compounds found in organisms, compounds produced by organisms, proteins, protein fragments, polysaccharides, cellulose, and carbon containing molecules with a molecular weight greater than or equal to about 150 daltons. The concentrate filtration membrane can be incorporated into a concentrate filtration unit having a cross-flow configuration or into a concentrate filtration unit having a plug-flow configuration. The concentrating compartment of the electrodeionization unit can receive a make up stream from a make up supply. A waste unit can receive a bleed stream from the concentrating compartment.

Another embodiment of a water purification system includes a side stream filtration membrane and a waste unit. The side stream filtration membrane can separate a fraction of the concentrate effluent stream from the concentrating compartment into a side permeate stream and a side reject stream, the waste unit can receive substantially all of the side reject stream, and the concentrate filtration membrane can receive the side permeate stream. Alternatively, the side stream filtration membrane can separate a fraction of the filtered concentrate effluent stream from the concentrate filtration membrane into a side permeate stream and a side reject stream, the waste unit can receive substantially all of the side reject stream, and the concentrating compartment can receive the side permeate stream. The side stream filtration membrane can include a microfiltration membrane, an ultrafiltration membrane, a nanofiltration membrane, a reverse osmosis membrane, or any combination of these.

An embodiment of a water purification system includes a make up stream supply. The concentrating compartment can receive a make up stream from the make up stream supply, and the EDI product stream can have a flow rate greater than or equal to 97% of the combined flow rate of the diluting feed stream and the make up stream. The concentrate filtration membrane can receive a make up stream from the make up stream supply, and the EDI product stream can have a flow rate greater than or equal to 97% of the combined flow rate of the diluting feed stream and the make up stream.

A water purification system according to the present invention can include a compartment separation membrane for filtering material passing between the diluting compartment and the concentrating compartment. In an embodiment, cleaning of the compartment separation membrane is needed at most one time per year.

A suitable concentrate filtration membrane can include a microfiltration membrane, an ultrafiltration membrane, a nanofiltration membrane, or any combination of these. A water purification system according to the present invention can include an antiscalant agent injection device, an antibiological agent injection device, an alkali metal hydroxide injection device, a salt injection device, or any combination of these injection devices. An antiscalant agent injection device can inject an antiscalant agent into the concentrate effluent stream and/or the filtered concentrate effluent stream; an antibiological agent injection device can inject an antibiological agent into the concentrate effluent stream and/or the filtered concentrate effluent stream; an alkali metal hydroxide injection device can inject an alkali metal hydroxide into the concentrate effluent stream and/or the filtered concentrate effluent stream; and a salt injection device can inject salt into the concentrate effluent stream and/or the filtered concentrate effluent stream. A water purification system can include a gas transfer membrane for separating dissolved or entrained gas from the concentrate effluent stream and/or the filtered concentrate effluent stream, an ultraviolet light device for irradiating the concentrate effluent stream and/or the filtered concentrate effluent stream, and/or an ion exchange unit for softening the concentrate effluent stream and/or the filtered concentrate effluent stream.

A water purification system according to the present invention can include a recirculation pump for increasing the flow rate of the concentrate effluent stream across a surface of the concentrate filtration membrane. The electrodeionization unit can include a counterflow electrodeionization unit.

In a method of water purification according to the present invention, an electrodeionization unit produces an EDI product stream and a concentrate effluent stream. Biological foulants can be removed from the concentrate effluent stream to produce a filtered concentrate effluent stream. The filtered concentrate effluent stream can be provided to a concentrating compartment of the electrodeionization unit. Impurities from a fraction of the concentrate effluent stream and/or a fraction of the filtered concentrate effluent stream can be removed to produce a side permeate stream. The side permeate stream can be provided to the concentrate effluent stream and/or the filtered concentrate effluent stream. The EDI product stream can have a flow rate greater than or equal to 97% of the flow rate of the diluting feed stream. A make up stream can be provided to the concentrate effluent stream and/or the filtered concentrate effluent stream. The removed biological foulants can be discharged to a waste unit. A bleed stream can be taken from the concentrate effluent stream and/or the filtered concentrate effluent stream, and the bleed stream can be discharged to a waste unit. A flow rate for the EDI product stream that is greater than or equal to 90% of the flow rate of the diluting feed stream can be selected.

### BRIEF DESCRIPTION OF THE DRAWINGS

FIG. 1 is a schematic of a water purification system according to an embodiment of the invention.

FIG. 2 is a schematic of a water purification system according to an embodiment of the invention including a side stream filtration membrane, a side permeate stream, a side reject stream, a waste unit, a make up stream, and a make up stream supply.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without parting from the spirit and scope of the invention. All references cited herein are incorporated by reference as if each had been individually incorporated.

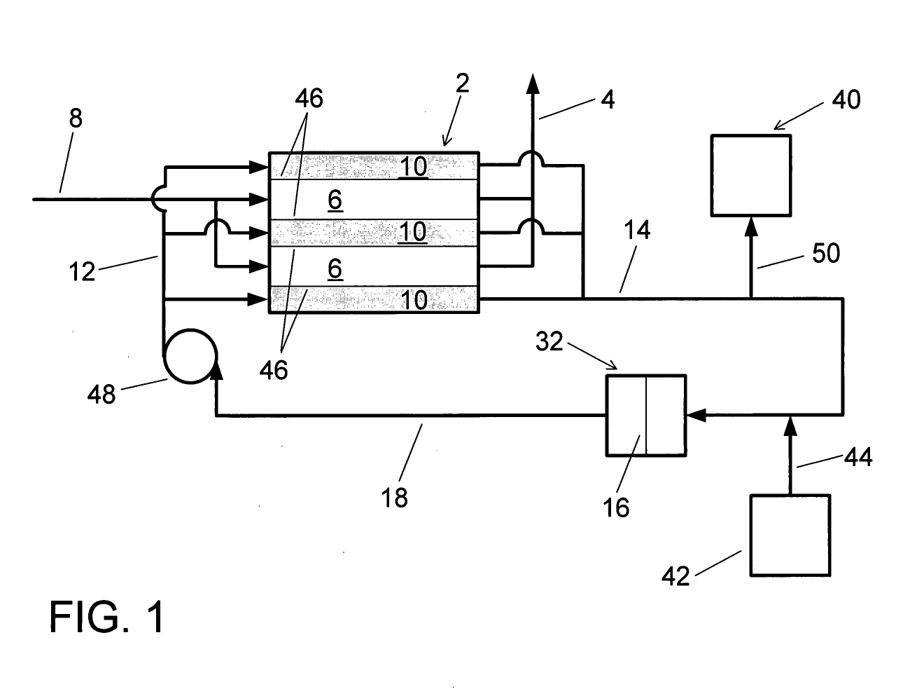

In an embodiment of a water purification system according to the present invention, shown in FIG. 1, an electrodeionization unit 2 for producing an EDI product stream 4 of purified water is shown. A diluting compartment 6 can receive a diluting feed stream 8. A concentrating compartment 10 can receive a concentrating feed stream 12 and can output a concentrate effluent stream 14. A concentrate filtration membrane 16 can remove biological foulants and other impurities such as colloids and particulates from the concentrate effluent stream 14 of the electrodeionization unit 2 to produce a filtered concentrate effluent stream 18. The concentrating compartment 10 of the electrodeionization unit 2 can receive the filtered concentrate effluent stream 18. A pump 48 can be located, for example, in the concentrate effluent stream 14 or the filtered concentrate effluent stream 18.

Biological foulants can include living or dead organisms. Such organisms can include, for example, bacteria, protists, protozoa, algae, fungi, yeast, pollen, or component cells of multicellular organisms. Biological foulants can also include, for example, fragments of organisms, such as subcellular organelles or cell walls. Biological foulants can include compounds found in or produced by organisms, for example, proteins, protein fragments, polysaccharides, or cellulose. Biological foulants can further include, for example, carbon containing molecules with a molecular weight greater than or equal to about 150 daltons.

The concentrate filtration membrane 16 can be incorporated into a concentrate filtration unit 32. A concentrate filtration unit 32 can have a cross-flow configuration or a plug-flow configuration. The concentrate filtration unit 32 can also have a configuration combining aspects of the cross-flow and plug-flow configurations. For example the concentrate filtration unit 32 can be designed to generally operate in a plug-flow configuration but be able to be switched to a cross-flow configuration in order to clean the surface of the concentrate filtration membrane 16.

The water purification system of the present invention can include a make up stream supply 42. The water purification system can accept filtered water, coarsely filtered water, or unfiltered water as a make up stream 44 from the make up stream supply 42. It is thought that the concentrate filtration membrane 16 can remove impurities such as biological foulants which may be introduced in the make up stream 44. If water of sufficient purity is introduced as the make up stream 44, the make up stream 44 can be introduced after the concentrate filtration membrane 16; that is, the make up stream 44 can be introduced into the filtered concentrate effluent stream 18 or into the concentrating compartments 10. Thus, the concentrate effluent stream 14, the filtered concentrate effluent stream 18, the concentrate filtration membrane 16, or the concentrating compartments 10 can receive a make up stream 44. The EDI product stream 4 can have a flow rate greater than or equal to 97% of the combined flow rate of the diluting feed stream 8 and the make up stream 44.

A waste unit 40 can receive a bleed stream 50 from the filtered concentrate effluent stream 18 or from the concentrate effluent stream 14. The waste unit 40 can receive a bleed stream 50 from the concentrate filtration membrane 16 or from the concentrating compartment 10.

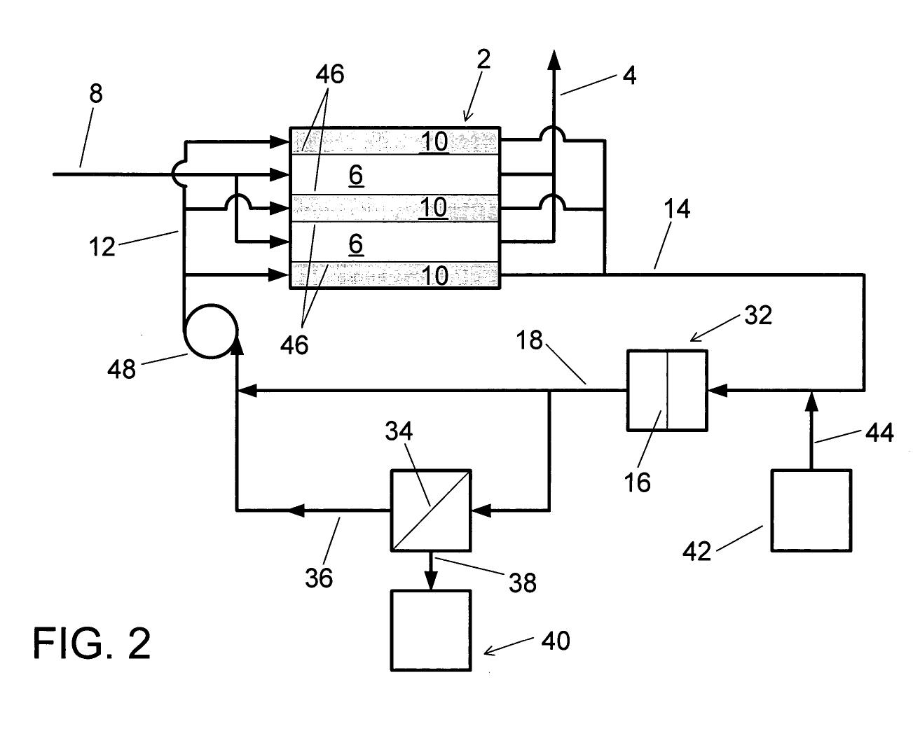

As shown in FIG. 2, the water purification system can include a side stream filtration membrane 34 capable of separating a fraction of the filtered concentrate effluent stream 18 into a side permeate stream 36 and a side reject stream 38. The side reject stream 38 can serve as a bleed stream; a waste unit 40 can receive substantially all of the side reject stream 38. The concentrating compartment 10 or the concentrate filtration membrane 16 can receive the side permeate stream 36.

The side stream filtration membrane 34 can include a microfiltration membrane, an ultrafiltration membrane, a nanofiltration membrane, a reverse-osmosis membrane, or any combination of these. Impurities removed by the side stream filtration membrane 34 can be passed to the side reject stream 38. By concentrating impurities in the side reject stream 38, the flow rate of water that is discharged in removing impurities in order to, for example, prevent impurities from exceeding a certain level in the concentrating compartments 10, can be reduced. By reducing the flow rate of water discharged in a bleed stream, for example, the side reject stream 38, the flow rate of water that must be added in a make up stream 44 is reduced, and, therefore, the overall consumption of water in producing a unit volume of the EDI product stream 4 is reduced. A side stream filtration membrane 34 can be used that removes monovalent salt as well as other impurities from the filtered concentrate effluent stream 18. Although an elevated concentration of monovalent salt in the concentrating compartments 10 may be desirable in order to maintain a high conductivity through the concentrating compartments 10, the concentration of monovalent salt in the concentrating compartments 10 should not exceed a certain level. A side stream filtration membrane 34 can, for example, include a reverse-osmosis membrane that can remove monovalent salt. Alternatively, a side stream filtration membrane 34 can be capable of separating a fraction of the concentrate effluent stream 14 into a side permeate stream 36 and a side reject stream 38; the concentrate filtration membrane 16 can receive the side permeate stream 36, and the side reject stream 38 can be received by a waste unit 40.

The electrodeionization unit 2 can include compartment separation membranes 46 which separate the diluting compartments 6 from the concentrating compartments 10. If a substance such as a biological foulant accumulates on a compartment separation membrane 46, for example, on the side of a compartment separation membrane 46 adjacent to the concentrating compartment 10, the accumulated substance can restrict the flow of ions through the membrane 46 and detrimentally affect the operation of the electrodeionization unit 2. For example, if a substance such as a biological foulant accumulates, the concentration of impurities remaining in the EDI product stream 4 can increase, or it can be necessary to reduce the flow rate of the diluting feed stream 8, and thus of the EDI product stream 4, to maintain a low concentration of impurities in the EDI product stream 4. If a substance such as a biological foulant accumulates on the side of a compartment separation membrane 46 adjacent to a concentrating compartment 10, the pressure drop associated with a given flow rate of fluid through the concentrating compartment 10 can increase. Then, application of a greater pressure differential across the concentrating compartment 10, between an inlet of the concentrating compartment 10 for receiving the concentrating feed stream 12 and an outlet of the concentrating compartment 10 for outputting a concentrate effluent stream 14, can be required to maintain the flow rate. The greater pressure differential required to maintain the flow rate can result in a greater power consumption. A reverse osmosis membrane supplied with, for example, surface water such as surface water with a concentration of total dissolved solids of from about 5 ppm to about 200 ppm can filter impurities such as dissolved solids, bacteria, and other biological foulants; the filtered water can be provided to the diluting stream 8 and the make up stream 44.

However, even if the make up stream 44 is supplied with water filtered through a reverse osmosis membrane, biological foulants can penetrate or bypass the reverse osmosis membrane to contaminate the concentrating compartment 10. For example, biological foulants can pass through defects in a reverse osmosis membrane, either defects originally present in or defects caused by damage to the reverse osmosis membrane, or through leaks in a seal around the reverse osmosis membrane. Once present in the concentrating compartment 10, biological foulants can accumulate, for example, living biological foulants such as bacteria can reproduce and multiply. Reproduction of living biological foulants in the concentrating compartment 10 can be a problem, because chlorine and other antibiological agents can be removed from the diluting feed stream 8 and the make up stream 44 to avoid chemical degradation of compartment separation membranes 46. As a result, the compartment separation membranes 46 need to be periodically cleaned, which can be a costly and inconvenient procedure. The compartment separation membranes 46 are expensive, and can only be cleaned a limited number of times before they must be replaced. Compartment separation membranes in conventional water purification systems that recycle water from a concentrating compartment back to the concentrating compartment can require frequent cleaning. However, compartment separation membranes 46 in a water purification system of the present invention can require a much lower frequency of cleaning than compartment separation membranes in a conventional water purification system, because the concentrate filtration membrane 16 can remove biological foulants and other impurities. For example, the frequency of required cleaning of compartment separation membranes in a conventional water purification system can be from about two to about four times greater than the frequency of required cleaning of compartment separation membranes 46 in water purification systems according to the present invention. For example, when water from a given source is filtered through a reverse osmosis membrane and provided as the make up stream to a concentrating feed stream in a conventional water purification system, compartment separation membranes in the electrodeionization unit of a conventional water purification system can require cleaning from about two to about four times per year. By contrast, when water from the same source is filtered through a reverse osmosis membrane and provided as the make up stream 44 to a water purification system according to the present invention, compartment separation membranes 46 in the electrodeionization unit 2 can need to be cleaned at most one time per year.

The concentrate filtration membrane 16 can include a microfiltration membrane, an ultrafiltration membrane, a nanofiltration membrane, or any combination of these. For example, the Capfil ultrafiltration membrane Model UFC M5, manufactured by X-Flow B.V. of Vriezenveen, The Netherlands, is specified as having a molecular weight cutoff of from 150,000 to 200,000 daltons. Examples of filters manufactured by GE Water Technologies of Trevose, Pa. include the following: the DS-E-500 microfiltration membrane, specified as having a pore size of 0.04 μm, the PW series ultrafiltration membranes, specified as having a molecular weight cutoff of 10,000 daltons, the PT8040F ultrafiltration membrane, specified as having a molecular weight cutoff of 6,000 daltons, and the DS-51 nanofiltration membrane, specified as having a molecular weight cutoff of 150 to 300 daltons for uncharged organic molecules. The HYDRAcap® Hollow Fiber Ultrafiltration Module, manufactured by Hydranautics of Oceanside, Calif. is specified as having a molecular weight cutoff of 150,000 daltons and can be operated in a plug flow (also known as direct flow or “dead-end” flow) mode and can be operated in a crossflow mode.

Water purification systems of the present invention can include one or more additional components. For example, the water purification system can include an antiscalant agent injection device which can inject an antiscalant agent into the concentrate effluent stream 14 and/or the filtered concentrate effluent stream 18. Examples of antiscalant agents include sulfuric acid, hydrochloric acid, polyacrylic acid, poly(acrylic-co-sulfonate), phosphonate antiscalants, sodium hexametaphosphate, EDTA complexing agent, CDTA complexing agent, amido succinic acid chelating agent, sodium bisulphite, and combinations of these and other antiscalant agents.

The water purification system can include an antibiological agent injection device. The antibiological agent injection device can inject an antibiological agent into the concentrate effluent stream 14 and/or the filtered concentrate effluent stream 18.

The water purification system can include a sodium hydroxide injection device. The sodium hydroxide injection device can inject sodium hydroxide into the concentrate effluent stream 14 and/or the filtered concentrate effluent stream 18. The injected sodium hydroxide reacts with carbon dioxide dissolved in the water to form sodium carbonate and sodium bicarbonate which remain in solution and do not produce scaling or fouling in the electrodeionization unit 2.

The water purification system can include a salt injection device for injecting salt, for example, a monovalent salt such as sodium chloride, into the fluid of the concentrate effluent stream 14 and/or the filtered concentrate effluent stream 18. A salt injection device can ensure a minimum concentration of salt in the concentrating compartments 10. A sufficient concentration of salt in a concentrating compartment 10 can result in a large conductance across the concentrating compartment 10.

Dissolved or entrained gas can be removed from water with a gas transfer unit having a gas transfer membrane. For example, carbon dioxide can be removed with such a gas transfer unit. The gas transfer unit can receive the filtered concentrate effluent stream 18, separate dissolved or entrained gas from the filtered concentrate effluent stream 18, and then provide the degassed, filtered stream to the concentrating compartment 10 of the electrodeionization unit 2. Alternatively, the gas transfer unit can receive the concentrate effluent stream 14, separate dissolved or entrained gas from the concentrate effluent stream 14, and then provide the degassed, treated stream to the concentrate filtration membrane 16.

The water purification system can include an ultraviolet light device. The device can irradiate the filtered concentrate effluent stream 18 with ultraviolet light before the filtered concentrate effluent stream 18 enters the concentrating compartment 10 of the electrodeionization unit 2. Alternatively, an ultraviolet light device can irradiate the concentrate effluent stream 14 with ultraviolet light before the concentrate effluent stream 14 enters the concentrate filtration membrane 16.

An ion exchange unit can receive the filtered concentrate effluent stream 18, and soften the fluid of the filtered concentrate effluent stream 18. The softened, filtered stream can then be provided to the concentrating compartment 10 of the electrodeionization unit 2. For example, an ion exchange unit can accept the filtered concentrate effluent stream 18 from a concentrate filtration membrane 16 that incorporates a microfiltration or ultrafiltration membrane. The ion exchange resin is understood to convert salts such as calcium carbonate or magnesium carbonate to more soluble sodium salts, thus reducing scaling and fouling of the surface of the compartment separation membranes 46 facing the concentrating compartments 10 of the electrodeionization unit 2. Alternatively, an ion exchange unit can receive the concentrate effluent stream 14, and soften the fluid of the concentrate effluent stream 14; the softened, filtered stream can then be provided to the concentrate filtration membrane 16.

The water purification system can include a recirculation pump for increasing the flow rate of the concentrate effluent stream 14 across the surface of the concentrate filtration membrane 16. The inlet of the recirculation pump can be fluidly connected, for example, upstream of the concentrate filtration membrane 16 and close to the surface of the concentrate filtration membrane 16; the outlet of the recirculation pump can be, for example, fluidly connected to the concentrate effluent stream 14.

In an embodiment, the electrodeionization unit 2 has a counterflow configuration, i.e., the fluid in the concentrating compartments 10 flows in a direction opposite to the direction in which the fluid in the diluting compartments 6 flows. The mass of an ionic species transferred from a diluting compartment 6 to a concentrating compartment 10 per unit time for a given area of a compartment separation membrane 46 can be greater for a counterflow configuration than for a parallel flow configuration.

In a method for purifying water according to the present invention, an EDI product stream 4 and a concentrate effluent stream 14 are produced with an electrodeionization unit 2. Biological foulants can be removed from the concentrate effluent stream 14 to produce a filtered concentrate effluent stream 18. The removed biological foulants can be discharged as waste. The filtered concentrate effluent stream 18 can be provided to a concentrating compartment 10 of the electrodeionization unit 2.

Impurities can be removed from a fraction of the filtered concentrate effluent stream 18 to produce a side permeate stream 36, and the side permeate stream 36 can be provided to the filtered concentrate effluent stream 18 and/or to the concentrate effluent stream 14. Impurities can be removed from the concentrate effluent stream 14 to produce a side permeate stream 36, and the side permeate stream 36 can be provided to the concentrate effluent stream 14 and/or to the filtered concentrate effluent stream 18. A make up stream 44 can be provided to the concentrate effluent stream 14 or to the filtered concentrate effluent stream 18.

The EDI product stream 4 can have a flow rate greater than or equal to 97% of the flow rate of the diluting feed stream 8.

A bleed stream can be taken from the concentrate effluent stream 14 and/or the filtered concentrate effluent stream 18, and the bleed stream can be discharged as waste.

A method can include the step of selecting a flow rate for the EDI product stream 4 that is greater than or equal to 90% of the flow rate of the diluting feed stream 8. For example, the flow rate of the make up stream 44 and the flow rate of a bleed stream, such as the side reject stream 38, can be selected to achieve this ratio.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A water purification system, comprising:
an electrodeionization unit for producing an EDI product stream, the unit comprising a diluting compartment for receiving a diluting feed stream and a concentrating compartment for receiving a concentrating feed stream and for outputting a concentrate effluent stream; and
a concentrate filtration membrane for removing a biological foulant from the concentrate effluent stream of the electrodeionization unit to produce a filtered concentrate effluent stream,
wherein the concentrating compartment of the electrodeionization unit is fluidly connected to the filtered concentrate effluent stream.

2. The system of claim 1, wherein the biological foulant is selected from the group consisting of bacteria, protists, protazoa, algae, fungi, yeast, pollen, component cells of multicellular organisms, fragments of organisms, subcellular organelles, cell walls, compounds found in organisms, compounds produced by organisms, proteins, protein fragments, polysaccharides, cellulose, and carbon containing molecules with a molecular weight greater than or equal to about 150 daltons.

3. The system of claim 1, wherein the concentrate filtration membrane is incorporated into a concentrate filtration unit having a cross-flow configuration.

4. The system of claim 1, wherein the concentrate filtration membrane is incorporated into a concentrate filtration unit having a plug-flow configuration.

5. The system of claim 1, further comprising:
a side stream filtration membrane capable of separating a fraction of the concentrate effluent stream from the concentrating compartment into a side permeate stream and a side reject stream; and
a waste unit for receiving substantially all of the side reject stream,
wherein the concentrate filtration membrane is capable of receiving the side permeate stream.

6. The system of claim 1, further comprising:
a side stream filtration membrane capable of separating a fraction of the filtered concentrate effluent stream from the concentrate filtration membrane into a side permeate stream and a side reject stream; and
a waste unit for receiving substantially all of the side reject stream,
wherein the concentrating compartment is capable of receiving the side permeate stream.

7. The system of claim 6, wherein the side stream filtration membrane comprises a membrane selected from at least one of a microfiltration membrane, an ultrafiltration membrane, a nanofiltration membrane, or a reverse osmosis membrane.

8. The system of claim 6, further comprising
a make up stream supply,
wherein the concentrating compartment is capable of receiving a make up stream from the make up stream supply, and
wherein the EDI product stream can have a flow rate greater than or equal to 97% of the combined flow rate of the diluting feed stream and the make up stream.

9. The system of claim 6, further comprising
a make up stream supply,
wherein the concentrate filtration membrane is capable of receiving a make up stream from the make up stream supply, and
wherein the EDI product stream can have a flow rate greater than or equal to 97% of the combined flow rate of the diluting feed stream and the make up stream.

10. The system of claim 1, further comprising
a compartment separation membrane for filtering material passing between the diluting compartment and the concentrating compartment,
wherein the compartment separation membrane need be cleaned at most one time per year.

11. The system of claim 1, wherein the concentrate filtration membrane comprises a membrane selected from at least one of a microfiltration membrane, an ultrafiltration membrane, or a nanofiltration membrane.

12. The system of claim 1, further comprising at least one of:
an antiscalant agent injection device for injecting an antiscalant agent into at least one of the concentrate effluent stream or the filtered concentrate effluent stream,
an antibiological agent injection device for injecting an antibiological agent into at least one of the concentrate effluent stream or the filtered concentrate effluent stream,
an alkali metal hydroxide injection device for injecting an alkali metal hydroxide into at least one of the concentrate effluent stream or the filtered concentrate effluent stream, or
a salt injection device for injecting salt into at least one of the concentrate effluent stream or the filtered concentrate effluent stream.

13. The system of claim 1, further comprising a gas transfer membrane for separating dissolved or entrained gas from at least one of the concentrate effluent stream or the filtered concentrate effluent stream.

14. The system of claim 1, further comprising an ultraviolet light device for irradiating at least one of the concentrate effluent stream or the filtered concentrate effluent stream.

15. The system of claim 1, further comprising an ion exchange unit for softening at least one of the concentrate effluent stream or the filtered concentrate effluent stream.

16. The system of claim 1, further comprising a recirculation pump for increasing the flow rate of the concentrate effluent stream across a surface of the concentrate filtration membrane.

17. The system of claim 1, wherein the electrodeionization unit comprises a counterflow electrodeionization unit.

18. A water purification system comprising:
an electrodeionization unit for producing an EDI product stream and comprising a diluting compartment for receiving a diluting feed stream and a concentrating compartment for receiving a concentrating feed stream and for outputting a concentrate effluent stream;
a concentrate filtration membrane for removing a biological foulant from the concentrate effluent stream to produce a filtered concentrate effluent stream;
a make up stream supply; and
a waste unit,
wherein the concentrating compartment is capable of receiving a make up stream from the make up stream supply,
wherein the waste unit is capable of receiving a bleed stream from the concentrating compartment, and
wherein the concentrating compartment is capable of receiving the filtered concentrate effluent stream.

19. The system of claim 18, wherein
the concentrate filtration membrane is incorporated into a concentrate filtration unit having a cross-flow configuration.

20. The system of claim 18, further comprising
a side stream filtration membrane comprising a reverse osmosis membrane and capable of separating a fraction of the filtered concentrate effluent stream into a side permeate stream and a side reject stream,
wherein the waste unit is capable of receiving substantially all of the side reject stream, and
wherein the concentrating compartment is capable of receiving the side permeate stream.

21. A method for purifying water, comprising the steps of:
producing an EDI product stream and a concentrate effluent stream with an electrodeionization unit;
removing biological foulants from the concentrate effluent stream to produce a filtered concentrate effluent stream; and
providing the filtered concentrate effluent stream to a concentrating compartment of the electrodeionization unit.

22. The method of claim 21, further comprising the steps of:
removing impurities from a fraction of at least one of the concentrate effluent stream or the filtered concentrate effluent stream to produce a side permeate stream; and
providing the side permeate stream to at least one of the concentrate effluent stream or the filtered concentrate effluent stream.

23. The method of claim 22, wherein the EDI product stream has a flow rate greater than or equal to 97% of the flow rate of a diluting feed stream.

24. The method of claim 21, further comprising the step of providing a make up stream to at least one of the concentrate effluent stream or the filtered concentrate effluent stream.

25. The method of claim 21, further comprising the step of discharging the removed biological foulants to a waste unit.

26. The method of claim 21, further comprising the steps of:
taking a bleed stream from at least one of the concentrate effluent stream or the filtered concentrate effluent stream; and
discharging the bleed stream to a waste unit.

27. The method of claim 21, further comprising the step of selecting a flow rate for the EDI product stream that is greater than or equal to 90% of the flow rate of a diluting feed stream.
